(19) United States
(12) Patent Application Publication
(10) Pub. No.: US 2025/0219330 A1
(43) Pub. Date: Jul. 3, 2025

(54) HIGH VOLTAGE SHIELDED ELECTRICAL CONNECTOR

(71) Applicant: Lear Corporation, Southfield, MI (US)

(72) Inventors: Zhipeng Bai, Shanghai (CN); Chao Fang, Shanghai (CN)

(73) Assignee: Lear Corporation, Southfield, MI (US)

(21) Appl. No.: 18/920,093

(22) Filed: Oct. 18, 2024

(30) Foreign Application Priority Data
Dec. 27, 2023 (CN) 202311826990.X

(51) Int. Cl. H01R 13/6581; H01R 13/627

(52) U.S. Cl. CPC H01R 13/6581; H01R 13/6272

(57) ABSTRACT

An electrical connector includes a connector housing. The connector housing defines a connector cavity. A terminal housing is disposed within the connector cavity. A shield is disposed within the connector cavity and is at least partially between the terminal housing and the connector cavity. The shield extends from a connection end to a contact end. The shield includes a first shield that extends from the connection end to the contact end. The shield also includes a second shield that is separable from the first shield and that extends from the connection end to the contact end. The first shield has a first side and a second side. One or more tabs on the first side engage the second shield. The second shield has a first side and a second side. One or more tabs on the second side of the second shield engage the first shield.

### FIELD

This disclosure relates to an electrical connector. More specifically, this disclosure relates to a high voltage electrical connector with an improved electromagnetic shield.

### BACKGROUND

Electrical components are often connected to each other using conductive cables, and electrical connectors attached to the cables allow the components to be connected at a desired time. For example, electrical components from different sources can be brought together during the manufacture of a larger assembly. In order to reduce electromagnetic interference, it is known to use an outer conductor on a cable and a shield in the electrical connector that is engaged with the outer conductor on the cable. It is desirable to provide an improved electrical connector with an improved electromagnetic shield.

### SUMMARY

Various example electrical connectors are described.

An example electrical connector includes a connector housing. The connector housing defines a connector cavity. A terminal housing is disposed within the connector cavity. A shield is disposed within the connector cavity and is at least partially between the terminal housing and the connector cavity. The shield extends from a connection end to a contact end. The shield includes a first shield that extends from the connection end to the contact end. The shield also includes a second shield that is separable from the first shield and that extends from the connection end to the contact end. The first shield has a first side and a second side. One or more tabs on the first side engage the second shield. The second shield has a first side and a second side. One or more tabs on the second side of the second shield engage the first shield.

Another example electrical connector includes a connector housing defining a connector cavity therethrough. A terminal housing is disposed within the connector cavity. A shield is disposed within the connector cavity, at least partially between the terminal housing and the connector housing. The shield extends from a connection end to a contact end. A connector position assurance is attached to the connector housing. The connector position assurance is moveable relative to the connector housing between a pre-lock position and a locked position. The connector position assurance includes an assurance latch. The connector housing includes a housing catch that engages the connector position assurance to deflect the assurance latch to a release position when the connector position assurance is moved from the pre-lock position to the locked position. The housing catch further engages the connector position assurance to prevent movement of the connector position assurance from the locked position to the pre-lock position.

Another example electrical connector includes a shield wherein the first shield has a first outward tab on the first side of the first shield and a second outward tab on the second side of the first shield. The first outward tab of the first shield and the second outward tab of the first shield are disposed on opposite sides of the shield axis. The second shield includes a first outward tab on the first side of the second shield and a second outward tab on the second side of the second shield. The first outward tab of the second shield and the second outward tab of the second shield disposed on opposite sides of the shield axis. The first outward tab of the first shield is disposed adjacent to the second outward tab of the second shield and the second outward tab of the first shield is disposed adjacent to the first outward tab of the second shield. Additionally, a connector position assurance is attached to the connector housing. The connector position assurance is moveable relative to the connector housing between a pre-lock position and a locked position. The connector position assurance includes an assurance catch. The connector housing includes a housing catch that engages the connector position assurance to deflect an assurance latch to a release position when the connector position assurance is moved from the pre-lock position to the locked position. The housing catch further engages the connector position assurance to prevent movement of the connector position assurance from the locked position to the pre-lock position. The connector housing includes a shroud that defines a window that is located farther from the connector cavity than the assurance latch. The assurance latch has a lift bar accessible through the window.

Additional understanding of these examples will become apparent to those skilled in the art from the following detailed description, when read in light of the accompanying drawings.

### BRIEF DESCRIPTION OF THE DRAWINGS

FIG. 1 is a perspective view of an example electrical connector.

FIG. 2 is a partially exploded view of the electrical connector illustrated in FIG. 1, showing an outer assembly and an inner assembly.

FIG. 3 is a partially exploded view of the inner assembly illustrated in FIG. 2.

FIG. 4 is an enlarged view of part of a shield illustrated in FIG. 3.

FIG. 5 is an enlarged view of a partially assembled inner assembly.

FIG. 6 is a cross-sectional view taken along line 6-6 in FIG. 5.

FIG. 7 is a cross-sectional view taken along the line 7-7 in FIG. 5.

FIG. 8 is a cross-sectional view taken along the line 8-8 in FIG. 5.

FIG. 9 is an enlarged perspective view of a connector position assurance illustrated in FIG. 1.

FIG. 10 is a cross-sectional view taken along the line 10-10 in FIG. 1 showing a portion of the electrical connector. The connector position assurance is shown in a pre-lock position.

FIG. 11 is a view similar to FIG. 10, with the connector position assurance shown in a locked position.

FIG. 12 is a view similar to FIG. 11, with an assurance latch on the connector position assurance shown moved to a release position.

FIG. 13 is a cross-sectional view taken along the line 13-13 in FIG. 1.

### DETAILED DESCRIPTION

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first shield could be termed a second shield, and, similarly, a second shield could be termed a first shield, without departing from the scope of the various described embodiments. The first shield and the second shield are both shields, but they are not the same shield.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

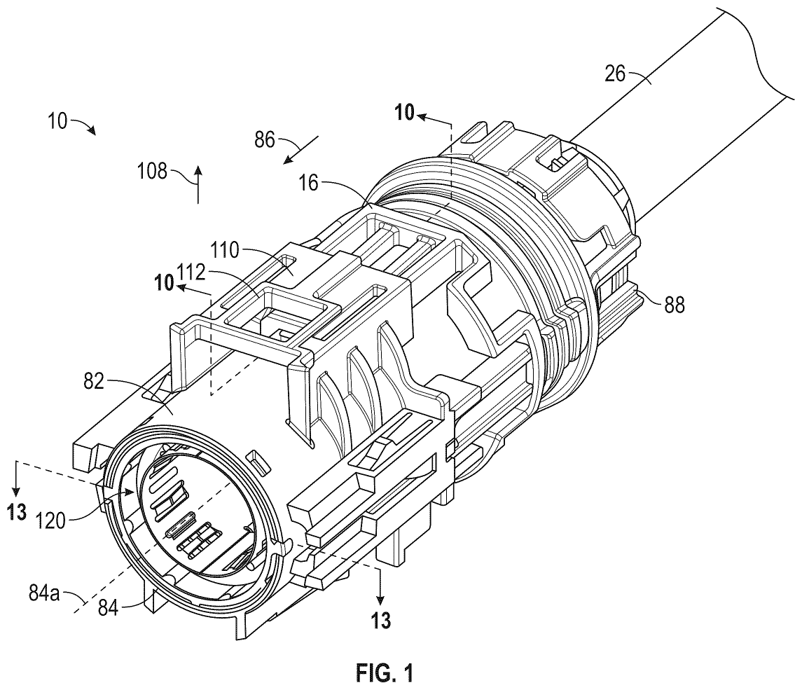

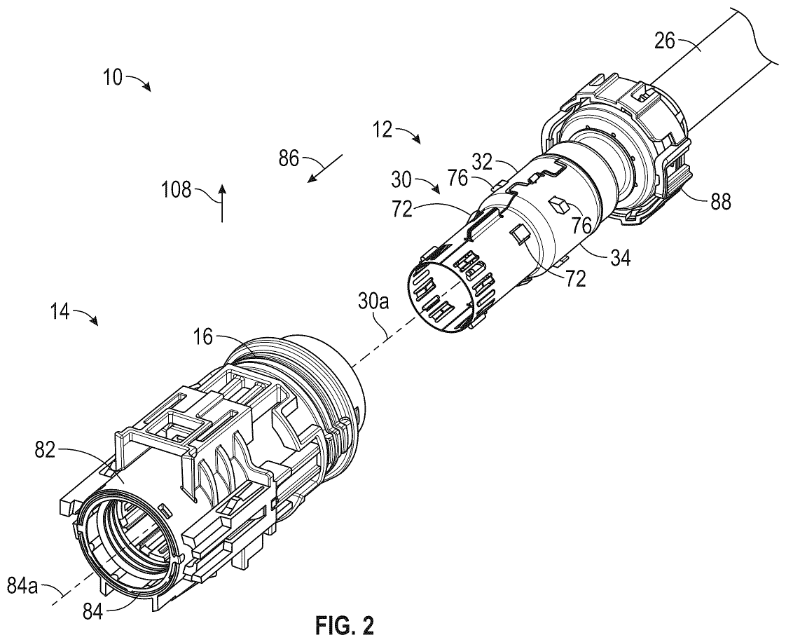

Referring now to the drawings there is illustrated in FIG. 1 a front perspective view of an electrical connector, indicated generally at 10. FIG. 2 is a partially exploded view of the electrical connector 10, showing an inner assembly, indicated generally at 12, and an outer assembly, indicated generally at 14, that includes a connector position assurance 16.

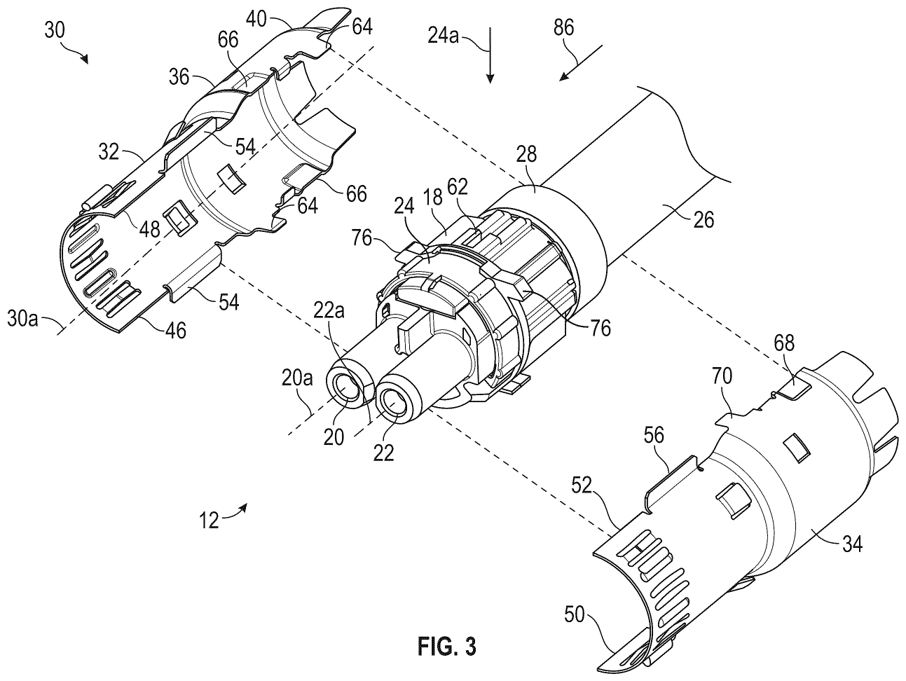

Referring to FIG. 3, there is illustrated a partially exploded view of the inner assembly 12. The inner assembly 12 includes a terminal housing 18. The illustrated terminal housing 18 is molded from plastic but may be made of any desired material and by any desired process. The illustrated terminal housing 18 includes two terminal cavities 20 and 22, each of which is adapted to accommodate an electrical terminal (not shown). Each terminal cavity 20 and 22 defines a respective terminal axis 20a and 22a. A terminal position assurance 24 is movable relative to the terminal housing 18 along in an assurance direction 24a, that is perpendicular to the terminal axes 20a and 22a. The terminal position assurance 24 is shown attached to the terminal housing 18 in an installed position wherein the terminal position assurance 24 retains the electrical terminals in their installed positions in the terminal cavities 20 and 22.

The terminal housing 18 is connected to a cable 26. The cable 26 includes conductors (not shown) that are connected to the electrical terminals. The illustrated cable 26 is a shielded cable and includes an outer conductor (not shown) that is electrically connect to a ferrule 28 during assembly of the inner assembly 12. The ferrule 28 is made of electrically conductive metal and is pressed onto the terminal housing 18.

The inner assembly 12 includes a shield, indicated generally at 30, disposed within the connector cavity 84 and at least partially between the terminal housing 18 and the connector housing 82, as described in more detail herein. The illustrated shield 30 extends from a connection end 40 to a contact end 44 that is adapted to engage a corresponding shield on a corresponding connector. The shield 30 includes a first shield 32 and a second shield 34. The first shield 32 and the second shield 34 are releasably attached to one another when assembled and the second shield 34 is separable from the first shield 32. Each of the first shield 32 and the second shield 34 has one or more tabs, as described in more detail herein. The one or more tabs of the first shield 32 engage with the one or more tabs of the second shield 34. The one or more tabs of the second shield 34 engage with the one or more tabs of the first shield 32. The illustrated first shield 32 and second shield 34 are made of sheet metal folded into the illustrated shapes. However, the first shield 32 and the second shield 34 may be made of any desired material and by any desired process. In the illustrated embodiment, the first shield 32 and the second shield 34 have the same shape and the same features, and only the first shield 32 will be described in detail. However, the first shield 32 and the second shield 34 may have any desired shapes.

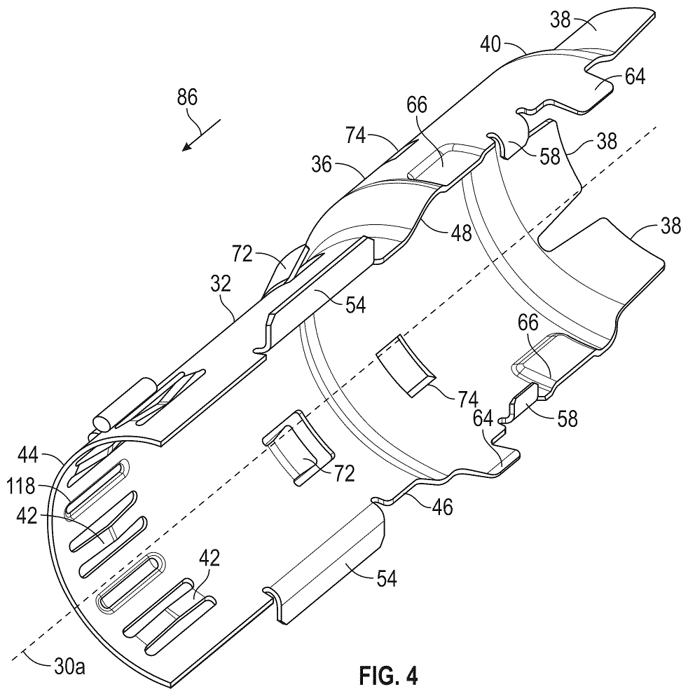

Referring to FIG. 4, there is shown an enlarged perspective view of the first shield 32. The first shield 32 includes a shield body 36. The shield body 36 is shaped and sized to fit around the outside of the terminal housing 18. The shield body 36 has a semi-circular shape that defines a shield axis 30a. The first shield 32 includes a plurality of connection tabs 38 at a connection end 40 of the shield body 36. The connection tabs 38 are adapted to provide an electrical connection between the first shield 32 and the outer conductor of the cable 26. The first shield 32 includes a plurality of contact arms 42 disposed near contact end 44 of the shield body 36 that is opposite the connection end 40. The contact arms 42 are adapted to provide an electrical connection between the first shield 32 and a corresponding shield (not shown) on a corresponding connector (not shown).

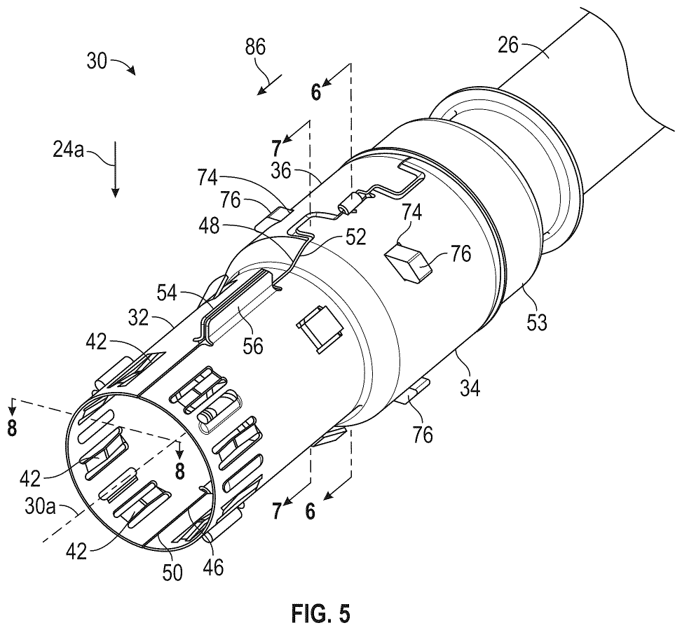

The first shield 32 includes a first side 46 that extends from the connection end 40 to the contact end 44. The first shield 32 also includes a second side 48 that extends from the connection end 40 to the contact end 44. The first side 46 and the second side 48 are disposed on opposite sides of the shield axis 30a. FIG. 5 is a perspective view similar to FIG. 3, with the shield 30 assembled around the terminal housing 18. As shown, the first side 46 of the first shield 32 is adjacent to a second side 50 of the second shield 34, and the second side 48 of the first shield 32 is adjacent to a first side 52 of the second shield 34. An outer ferrule 53 is attached to the cable 26 and is disposed at the connection end 40 of the first shield 32. The outer ferrule 53 is positioned outside the connection tabs 38 (not visible in FIG. 5) and presses the connection tabs 38 into contact with the outer conductor of the cable 26.

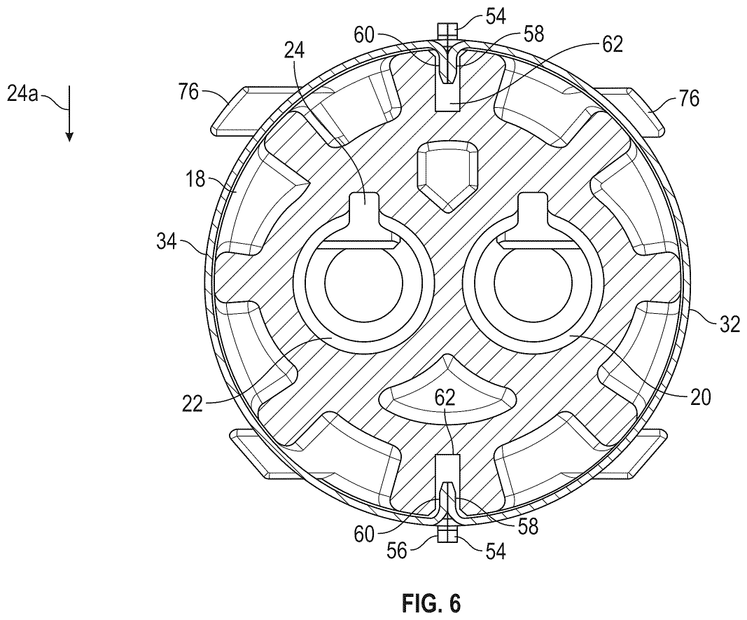

Referring back to FIG. 4, the first shield 32 includes outward tabs 54. The illustrated first shield 32 includes two outward tabs 54, a first outward tab 54 is disposed on the first side 46, and a second outward tab 54 is disposed on the second side 48. However, the first shield 32 may have any desired number of outward tabs 54. The outward tabs 54 extend radially away from the shield axis 30a. The illustrated outward tabs 54 are disposed on opposite sides of the shield axis 30a from each other. The illustrated second shield 34 includes two outward tabs 56, a first outward tab 56 disposed on the first side 52, and a second outward tab 56 disposed on the second side 50. However, the second shield 34 may have any desired number of outward tabs 56. The outward tabs 56 extend radially away from the shield axis 30a. The illustrated outward tabs 56 are disposed on opposite sides of the shield axis 30a from each other. Referring back to FIGS. 5 and 6, when the shield 30 is assembled, the first outward tab 54 on the first side 46 of the first shield 32 is disposed adjacent to and engaging a second outward tab 56 on the second side 50 of the second shield 34.

Referring back to FIG. 4, the first shield 32 also includes inward tabs 58. The illustrated first shield 32 includes two inward tabs 58, a first inward tab 58 disposed on the first side 46, and a second inward tab 58 disposed on the second side 48. However, the first shield 32 may have any desired number of inward tabs 58. The inward tabs 58 extend radially toward the shield axis 30a. The illustrated inward tabs 58 are disposed on opposite sides of the shield axis 30a from each other. The second shield 34 also includes inward tabs 60. The illustrated second shield 34 includes two inward tabs 60, a first inward tab 60 disposed on the first side 52, and a second inward tab 60 disposed on the second side 50. However, the second shield 34 may have any desired number of inward tabs 60. The inward tabs 60 extend radially toward the shield axis 30a. The illustrated inward tabs 60 are disposed on opposite sides of the shield axis 30a from each other.

Referring to FIG. 6, there is illustrated a cross-sectional view taken along the line 6-6 of FIG. 5. As shown, when the shield 30 is assembled, the first inward tab 58 of the first shield 32 is disposed adjacent to and engaging the second inward tab 60 of the second shield 34 and the second inward tab 58 of the first shield 32 is disposed adjacent to and engaging the first inward tab 60 of the second shield 34. The first inward tab 58 of the first shield 32 and the second inward tab 60 of the second shield 34 are disposed in a first inward seat 62 on the terminal housing 18 and the second inward tab 58 of the first shield 32 and the first inward tab 60 of the second shield 34 are disposed in a second inward seat 62 on the terminal housing 18.

Referring back to FIG. 4, the first shield 32 also includes overlap tabs 64. The illustrated first shield 32 includes two overlap tabs 64, a first overlap tab 64 disposed on the first side 46, and a second overlap tab 64 disposed on the second side 48. However, the first shield 32 may have any desired number of overlap tabs 64. Each overlap tab of the overlap tabs 64 extends from its respective side. The illustrated overlap tabs 64 extend substantially tangentially from the shield body 36. The first shield 32 also includes overlap tab seats 66. The illustrated first shield 32 includes two overlap tab seats 66, a first overlap tab seat 66 disposed on the first side 46, and a second overlap tab seat 66 disposed on the second side 48. Each of the overlap tab seats 66 is disposed on the opposite side of the shield axis 30a from a respective one of the overlap tabs 64. Each of the illustrated overlap tab seats 66 is an emboss stamped into an outer surface of the shield body 36. However, the overlap tab seats 66 may be disposed on any desired part of the first shield 32. The second shield 34 includes overlap tabs 70. The illustrated second shield 34 includes two overlap tabs 70, a first overlap tab 70 disposed on the first side 52, and a second overlap tab 70 disposed on the second side 50. However, the second shield 34 may have any desired number of overlap tabs 70. Each overlap tab of the overlap tabs 70 extends from its respective side. The illustrated overlap tabs 70 extend substantially tangentially from the shield body 36. The second shield 34 also includes overlap tab seats 68. The illustrated second shield 34 includes two overlap tab seats 68, a first overlap tab seat 68 disposed on the first side 52, and a second overlap tab seat 68 disposed on the second side 50. Each of the overlap tab seats 68 is disposed on the opposite side of the shield axis 30a from a respective one of the overlap tabs 70. Each of the illustrated overlap tab seat 68 is an emboss stamped into an outer surface of the shield body 36. However, the overlap tab seats 68 may be disposed on any desired part of the second shield 34.

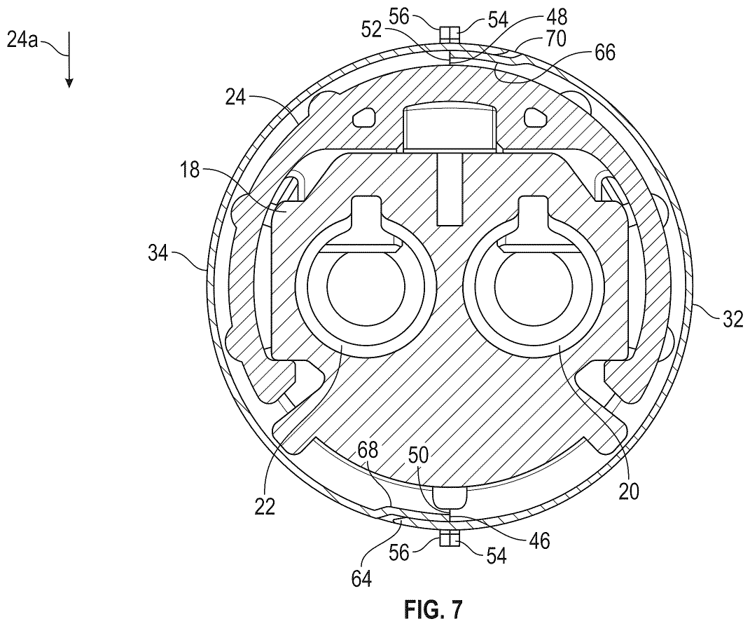

Referring now to FIG. 7, there is illustrated a cross-sectional view taken along the line 7-7 of FIG. 5. As shown, when the shield 30 is assembled, the first overlap tab 64 of the first shield 32 is disposed in the second overlap tab seat 68 of the second shield 34 and the second overlap tab 64 of the first shield 32 is disposed in the first overlap tab seat 68 of the second shield 34. Further, when the shield 30 is assembled, the second overlap tab 70 of the second shield 34 is disposed in the first overlap tab seat 66 of the first shield 32 and the first overlap tab 70 of the second shield 34 is disposed in the second overlap tab seat 66 of the first shield 32.

Referring back to FIG. 4, the first shield 32 also includes locking lances 72 that are cut free from the shield body 36 on three sides and provide a lock to retain the shield 30 in the outer assembly 14 when the electrical connector 10 is assembled. Additionally, the first shield includes openings 74 that are adapted to allow assembly guides 76 to extend from the terminal housing 18 through the shield 30, as shown in FIG. 5.

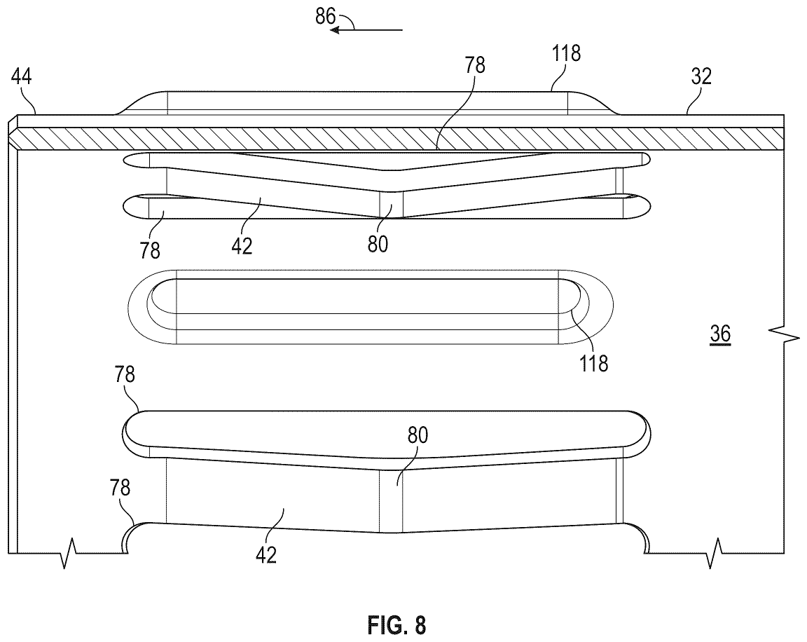

FIG. 8 is a cross-sectional view taken along the line 8-8 of FIG. 5, showing a portion of the first shield 32 including some of the contact arms 42. Each illustrated contact arm 42 is connected to the shield body 36 at opposite axial ends and includes an axial cut 78 on either side. The illustrated contact arms 42 are bent inwardly, towards the shield axis 30a, to a respective contact region 80. The contact arms 42 are adapted to engage the corresponding shield on the corresponding connector when the electrical connector 10 is mated with the corresponding connector, in order to provide electrical communication between the corresponding shield, the shield 30, and the outer conductor of the cable 26.

Referring back to FIG. 3, the shield 30 is attached to the terminal housing 18 by positioning the first shield 32 and the second shield 34 on opposite sides of the terminal housing 18 with the first side 46 of the first shield 32 facing the second side 50 of the second shield 34, and the second side 48 of the first shield 32 facing the first side 52 of the second shield 34. The first shield 32 and the second shield 34 are then moved to engage one another and the terminal housing 18. When the shield 30 is attached to the terminal housing 18, the shield axis 30a is substantially parallel to the terminal axes 20a and 22a.

Referring back to FIG. 2, the outer assembly 14 includes a connector housing 82. The illustrated connector housing 82 is molded from plastic but may be made of any desired material and by any desired process. The connector housing 82 defines a connector cavity 84 extending therethrough. The connector cavity 84 is adapted to accommodate the inner assembly 12. In the illustrated embodiment, the terminal housing 18 is disposed within the connector cavity 84. The connector cavity 84 defines a connector axis 84a.

In order to connect the inner assembly 12 to the outer assembly 14, the inner assembly 12 is first positioned adjacent to the outer assembly 14, with the shield axis 30a parallel to the connector axis 84a. The inner assembly 12 is then moved parallel to the shield axis 30a in an assembly direction 86 towards the outer assembly 14, so that the inner assembly 12 enters the connector cavity 84. The assembly guides 76 on the inner assembly 12 are adapted to cooperate with guide channels (not shown) on the connector housing 82 to properly position the inner assembly 12 relative to the connector housing 82. When the inner assembly 12 is moved in the assembly direction 86 relative to the connector housing 82 to an assembled position shown in FIG. 1, the locking lances 72 on the inner assembly 12 engage the connector housing 82 in order to retain the inner assembly 12 in the assembled position. An endcap 88 disposed around the cable 26 is then attached to the connector housing 82 in order to further retain the inner assembly 12 in the assembled position.

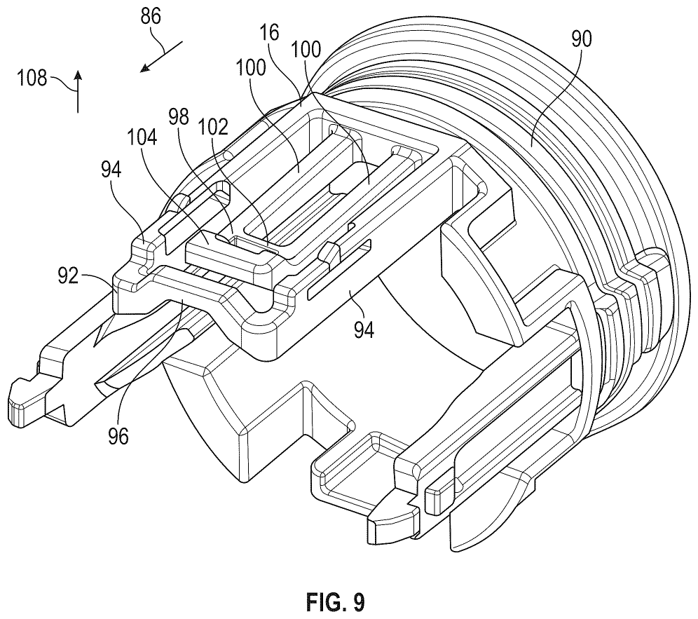

Referring to FIG. 9 there is illustrated a front perspective view of the connector position assurance 16 from FIG. 1. The illustrated connector position assurance 16 is molded from plastic. However, the connector position assurance 16 may be made of any desired material and by and desired process. The connector position assurance 16 includes an assurance body 90. The illustrated assurance body 90 has a circular cross-sectional shape and is adapted to fit around the outside of the connector housing 82, as shown in FIGS. 1 and 2. The connector position assurance 16 is attached to the connector housing 82 and is moveable relative to the connector housing 82 between a pre-lock position (shown in FIGS. 1 and 2) and a locked position.

As shown in FIG. 9, the connector position assurance 16 includes an assurance block 92 that is fixed to the assurance body 90. The assurance block 92 includes two guide arms 94 that extend from the assurance body 90 in the assembly direction 86. An assurance stop 96 is connected to the two guide arms 94 at outer ends thereof. The connector position assurance 16 also includes an assurance latch 98 that is attached to the assurance body 90. The assurance latch 98 includes two latch arms 100 that extend from the assurance body 90 in the assembly direction 86. In the illustrated embodiment, the two latch arms 100 are disposed between the guide arms 94. An assurance catch 102 is connected to the two latch arms 100 between the outer ends thereof and the assurance body 90. The assurance latch 98 also includes a lift bar 104. The illustrated lift bar 104 is connected to the two latch arms 100 at the outer ends thereof.

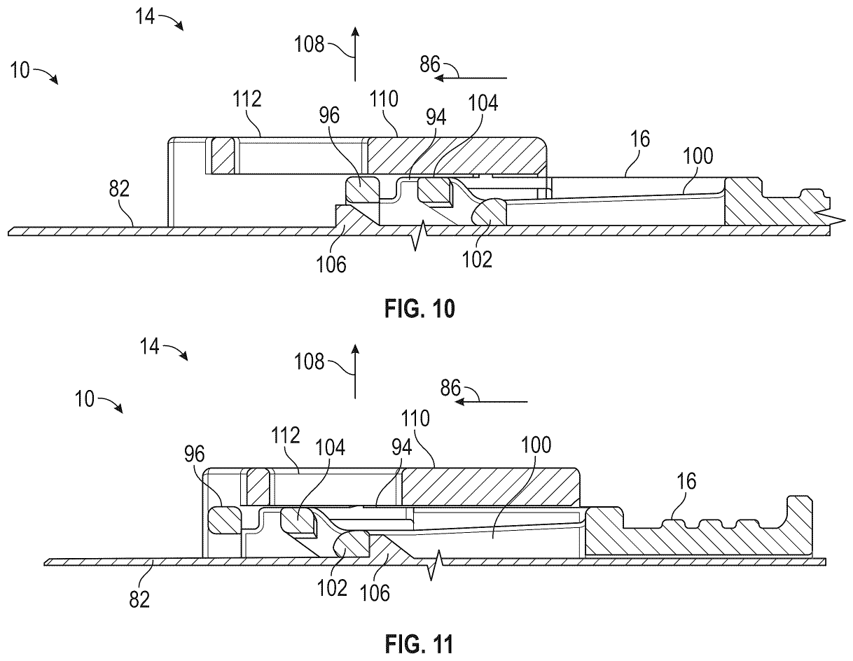

Referring to FIG. 10, there is illustrated a cross-sectional view taken along the line 10-10 of FIG. 1. FIG. 10 illustrates a portion of the outer assembly 14, including the connector position assurance 16 in the pre-lock position. In order to move the connector position assurance 16 to the locked position, the connector position assurance 16 is moved in the assembly direction 86 relative to the connector housing 82. The connector housing 82 includes a housing catch 106 that is disposed between the axial ends of the connector housing 82. When the connector position assurance 16 is moved from the pre-lock position towards the locked position, the housing catch 106 engages the assurance catch 102, and the assurance catch 102 is pushed in a release direction 108 away from the connector axis 84a. This causes the latch arms 100 to bend relative to the assurance body 90, and both the assurance catch 102 and the lift bar 104 are moved to a release position.

When the connector position assurance 16 is moved farther in the assembly direction 86 relative to the connector housing 82 to the locked position, the housing catch 106 no longer engages the assurance catch 102, and the assurance catch 102 is able to rebound opposite the release direction 108 toward the connector axis 84a. This puts the connector position assurance 16 in the locked position, illustrated in FIG. 11. When the connector position assurance 16 is in the locked position, the housing catch 106 engages the assurance catch 102 to prevent the connector position assurance 16 from being moved opposite the assembly direction 86 towards the pre-lock position.

As shown in FIG. 1, the connector housing 82 includes a shroud 110 that is configured to house at least a part of the connector position assurance 16. The shroud 110 defines a window 112. As shown in FIG. 11, when the connector position assurance 16 is in the locked position, the window 112 allows access to the lift bar 104 (e.g., the lift bar 104 is accessible through the window 112). In the illustrated embodiment, at least part of the window 112 is disposed in the release direction 108 from the lift bar 104 when the connector position assurance 16 in the locked position.

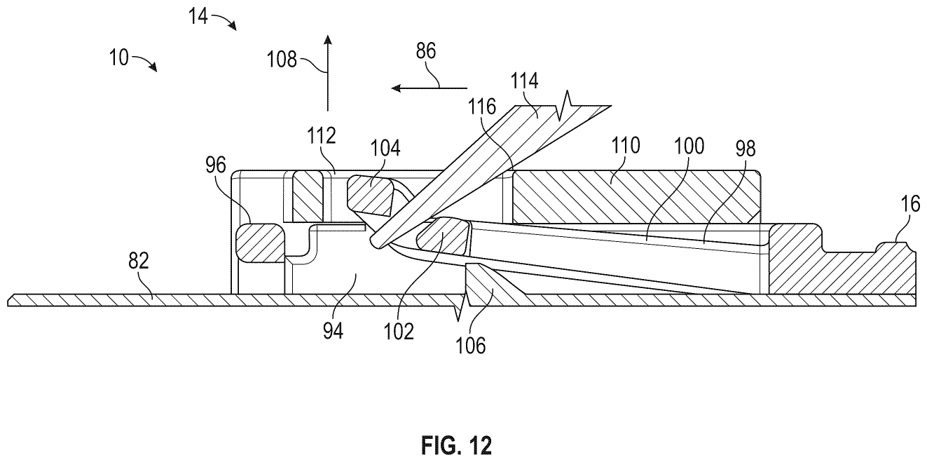

As shown in FIG. 12, in order to move the connector position assurance 16 from the locked position opposite the assembly direction 86 towards the pre-lock position, an operator may insert a tool 114 through the window 112 to engage the lift bar 104 on the assurance latch 98. The illustrated tool 114 is a screwdriver but may be any desired type of device. The window 112 includes a pry surface 116 on which the operator may rest the tool 114 to act as a fulcrum in order to apply a levered force on the lift bar 104. By applying a force on the lift bar 104, the assurance latch 98 is able to be moved in the release direction 108 relative to the connector housing 82 to the release position. This also moves the assurance catch 102 relative to the connector housing 82 and relative to the housing catch 106.

When the assurance latch 98 is in the release position, the connector position assurance 16 is able to be moved relative to the connector housing 82 toward the pre-lock position. The operator may release the force on the lift bar 104 to allow the assurance latch 98 to rebound from the release position, while the connector position assurance 16 is moved to the pre-lock position shown in FIG. 10.

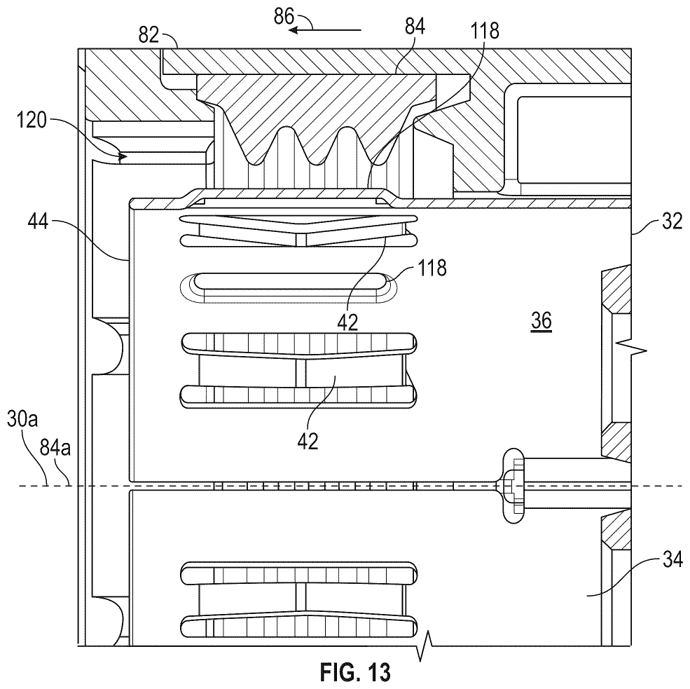

Referring back to FIG. 4, the first shield 32 includes a plurality of ridges 118 disposed near the contact end 44. In the illustrated embodiment, there is one ridge 118 between adjacent contact arms 42. The illustrated ridges 118 are outward embosses in the first shield 32. Two of the ridges 118 are shown in FIG. 8. Referring to FIG. 13, there is illustrated a cross-sectional view taken along the line 13-13 of FIG. 1, taken through one of the ridges 118. As shown, when the electrical connector 10 is assembled, the contact end 44 of the shield body 36 is disposed in the connector cavity 84 with a space 120 defined between the shield 30 and the side wall of the connector cavity 84. As shown in FIG. 1, the space 120 extends around the whole contact end 44 of the shield 30. As shown in FIG. 13, the ridges 118 extend into the space 120. When the electrical connector 10 is mated with the corresponding connector, part of the corresponding connector is disposed in the space 120. The ridges 118 are adapted to engage the corresponding connector to press the contact arms 42 inwardly towards the connector axis 84a and into engagement with the corresponding shield.

Those with ordinary skill in the art will appreciate that various modifications and alternatives for the described and illustrated embodiments can be developed in light of the overall teachings of the disclosure, and that the various elements and features of one example described and illustrated herein can be combined with various elements and features of another example without departing from the scope of the invention. Accordingly, the particular examples disclosed herein have been selected by the inventor(s) simply to describe and illustrate examples of the invention and are not intended to limit the scope of the invention or its protection, which is to be given the full breadth of the appended claims and any and all equivalents thereof.

What is claimed is:

1. An electrical connector comprising:
a connector housing defining a connector cavity therethrough;
a terminal housing disposed within the connector cavity; and
a shield disposed within the connector cavity and at least partially between the terminal housing and the connector housing, the shield extending from a connection end to a contact end, the shield including a first shield and a second shield, the first shield extending from the connection end to the contact end, the second shield separable from the first shield and extending from the connection end to the contact end, the first shield having a first side, a second side, and one or more tabs on the first side that engage the second shield, the second shield having a first side, a second side, and one or more tabs on the second side of the second shield that engage the first shield.

2. The electrical connector of claim 1, wherein the shield defines a shield axis;
wherein the one or more tabs of the first shield includes a first outward tab;
further comprising a second outward tab disposed on the second side of the first shield, the first outward tab of the first shield and the second outward tab of the first shield disposed on opposite sides of the shield axis;
wherein the one or more tabs of the second shield includes a second outward tab;
further comprising a first outward tab disposed on the first side of the second shield, the first outward tab of the second shield and the second outward tab of the second shield disposed on opposite sides of the shield axis; and
wherein the first outward tab of the first shield is disposed adjacent to the second outward tab of the second shield and the second outward tab of the first shield is disposed adjacent to the first outward tab of the second shield.

3. The electrical connector of claim 2, wherein each of the first outward tab of the first shield, the second outward tab of the first shield, the first outward tab of the second shield, and the second outward tab of the second shield extends away from the shield axis.

4. The electrical connector of claim 1, wherein the shield defines a shield axis;
wherein the one or more tabs of the first shield includes a first inward tab;
further comprising a second inward tab disposed on the second side of the first shield, the first inward tab of the first shield and the second inward tab of the first shield disposed on opposite sides of the shield axis;
wherein the one or more tabs of the second shield includes a second inward tab;
further comprising a first inward tab disposed on the first side of the second shield, the first inward tab of the second shield and the second inward tab of the second shield disposed on opposite sides of the shield axis; and
wherein the first inward tab of the first shield is disposed adjacent to the second inward tab of the second shield and the second inward tab of the first shield is disposed adjacent to the first inward tab of the second shield.

5. The electrical connector of claim 4, wherein each of the first inward tab of the first shield, the second inward tab of the first shield, the first inward tab of the second shield, and the second inward tab of the second shield extends towards the shield axis.

6. The electrical connector of claim 4, wherein the terminal housing defines a first inward seat and a second inward seat; and
wherein the first inward tab of the first shield and the second inward tab of the second shield are disposed in the first inward seat and the second inward tab of the first shield and the first inward tab of the second shield are disposed in the second inward seat.

7. The electrical connector of claim 1, wherein the shield defines a shield axis;
wherein the one or more tabs of the first shield includes a first overlap tab;
further comprising a second overlap tab seat disposed on the second side of the first shield, the first overlap tab and the second overlap tab seat disposed on opposite sides of the shield axis;
wherein the one or more tabs of the second shield includes a second overlap tab seat;
further comprising a first overlap tab disposed on the first side of the second shield, the first overlap tab and the second overlap tab seat disposed on opposite sides of the shield axis; and
wherein the first overlap tab of the first shield is disposed in the second overlap tab seat of the second shield and the first overlap tab of the second shield is disposed in the second overlap tab seat of the first shield.

8. The electrical connector of claim 1, wherein the shield defines a shield axis;
wherein the one or more tabs of the first shield includes a first outward tab and a first inward tab;
further comprising a second outward tab disposed on the second side of the first shield and a second inward tab disposed on the second side of the first shield, the first outward tab of the first shield and the second outward tab of the first shield disposed on opposite sides of the shield axis, the first inward tab of the first shield and the second inward tab of the first shield disposed on opposite sides of the shield axis;
wherein the one or more tabs of the second shield includes a second outward tab and a second inward tab;
further comprising a first outward tab disposed on the first side of the second shield and a first inward tab disposed on the first side of the second shield, the first outward tab of the second shield and the second outward tab of the second shield disposed on opposite sides of the shield axis, the first inward tab of the second shield and the second inward tab of the second shield disposed on opposite sides of the shield axis;
wherein the first outward tab of the first shield is disposed adjacent to the second outward tab of the second shield and the second outward tab of the first shield is disposed adjacent to the first outward tab of the second shield; and
wherein the first inward tab of the first shield is disposed adjacent to the second inward tab of the second shield and the second inward tab of the first shield is disposed adjacent to the first inward tab of the second shield.

9. The electrical connector of claim 8, wherein the terminal housing defines a first inward seat and a second inward seat; and
wherein the first inward tab of the first shield and the second inward tab of the second shield are disposed in the first inward seat and the second inward tab of the first shield and the first inward tab of the second shield are disposed in the second inward seat.

10. The electrical connector of claim 1, wherein the shield defines a shield axis;
wherein the one or more tabs of the first shield includes a first outward tab and a first overlap tab;
further comprising a second outward tab disposed on the second side of the first shield and a second overlap tab seat disposed on the second side of the first shield, the first outward tab of the first shield and the second outward tab of the first shield disposed on opposite sides of the shield axis, the first overlap tab and the second overlap tab seat disposed on opposite sides of the shield axis;
wherein the one or more tabs of the second shield includes a second outward tab and a second overlap tab seat;
further comprising a first outward tab disposed on the first side of the second shield and a first overlap tab disposed on the first side of the second shield, the first outward tab of the second shield and the second outward tab of the second shield disposed on opposite sides of the shield axis, the first overlap tab and the second overlap tab seat disposed on opposite sides of the shield axis;
wherein the first outward tab of the first shield is disposed adjacent to the second outward tab of the second shield and the second outward tab of the first shield is disposed adjacent to the first outward tab of the second shield; and
wherein the first overlap tab of the first shield is disposed in the second overlap tab seat of the second shield and the first overlap tab of the second shield is disposed in the second overlap tab seat of the first shield.

11. The electrical connector of claim 1, wherein the shield defines a shield axis;
wherein the one or more tabs of the first shield includes a first inward tab and a first overlap tab;
further comprising a second inward tab disposed on the second side of the first shield and a second overlap tab seat disposed on the second side of the first shield, the first inward tab of the first shield and the second inward tab of the first shield disposed on opposite sides of the shield axis, the first overlap tab and the second overlap tab seat disposed on opposite sides of the shield axis;
wherein the one or more tabs of the second shield includes a second inward tab and a second overlap tab seat;
further comprising a first inward tab disposed on the first side of the second shield and a first overlap tab disposed on the first side of the second shield, the first inward tab of the second shield and the second inward tab of the second shield disposed on opposite sides of the shield axis, the first overlap tab and the second overlap tab seat disposed on opposite sides of the shield axis;
wherein the first inward tab of the first shield is disposed adjacent to the second inward tab of the second shield and the second inward tab of the first shield is disposed adjacent to the first inward tab of the second shield; and
wherein the first overlap tab of the first shield is disposed in the second overlap tab seat of the second shield and the first overlap tab of the second shield is disposed in the second overlap tab seat of the first shield.

12. The electrical connector of claim 11, wherein the terminal housing defines a first inward seat and a second inward seat; and
wherein the first inward tab of the first shield and the second inward tab of the second shield are disposed in the first inward seat and the second inward tab of the first shield and the first inward tab of the second shield are disposed in the second inward seat.

13. The electrical connector of claim 1, wherein the shield defines a shield axis;
wherein the one or more tabs of the first shield includes a first outward tab, a first inward tab, and a first overlap tab;
further comprising a second outward tab disposed on the second side of the first shield, a second inward tab disposed on the second side of the first shield, and a second overlap tab seat disposed on the second side of the first shield, the first outward tab of the first shield and the second outward tab of the first shield disposed on opposite sides of the shield axis, the first inward tab of the first shield and the second inward tab of the first shield disposed on opposite sides of the shield axis, the first overlap tab and the second overlap tab seat disposed on opposite sides of the shield axis;
wherein the one or more tabs of the second shield includes a second outward tab, a second inward tab, and a second overlap tab seat;
further comprising a first outward tab disposed on the first side of the second shield, a first inward tab disposed on the first side of the second shield, and a first overlap tab disposed on the first side of the second shield, the first outward tab of the second shield and the second outward tab of the second shield disposed on opposite sides of the shield axis, the first inward tab of the second shield and the second inward tab of the second shield disposed on opposite sides of the shield axis, the first overlap tab and the second overlap tab seat disposed on opposite sides of the shield axis;
wherein the first outward tab of the first shield is disposed adjacent to the second outward tab of the second shield and the second outward tab of the first shield is disposed adjacent to the first outward tab of the second shield;
wherein the first inward tab of the first shield is disposed adjacent to the second inward tab of the second shield and the second inward tab of the first shield is disposed adjacent to the first inward tab of the second shield; and
wherein the first overlap tab of the first shield is disposed in the second overlap tab seat of the second shield and the first overlap tab of the second shield is disposed in the second overlap tab seat of the first shield.

14. The electrical connector of claim 13, wherein the terminal housing defines a first inward seat and a second inward seat; and
wherein the first inward tab of the first shield and the second inward tab of the second shield are disposed in the first inward seat and the second inward tab of the first shield and the first inward tab of the second shield are disposed in the second inward seat.

15. The electrical connector of claim 1, further comprising a connector position assurance attached to the connector housing, the connector position assurance moveable relative to the connector housing between a pre-lock position and a locked position, the connector position assurance including an assurance latch; and
wherein the connector housing including a housing catch that engages the connector position assurance to deflect the assurance latch to a release position when the connector position assurance is moved from the pre-lock position to the locked position, and that engages the connector position assurance to prevent movement of the connector position assurance from the locked position to the pre-lock position.

16. The electrical connector of claim 15, wherein the connector housing includes a shroud defining a window that is located farther from the connector cavity than the assurance latch; and
wherein the assurance latch has a lift bar accessible through the window.

17. An electrical connector comprising:
a connector housing defining a connector cavity therethrough;
a terminal housing disposed within the connector cavity;
a shield disposed within the connector cavity and at least partially between the terminal housing and the connector housing, the shield extending from a connection end to a contact end; and
a connector position assurance attached to the connector housing, the connector position assurance moveable relative to the connector housing between a pre-lock position and a locked position, the connector position assurance including an assurance latch;
wherein the connector housing including a housing catch that engages the connector position assurance to deflect the assurance latch to a release position when the connector position assurance is moved from the pre-lock position to the locked position, and that engages the connector position assurance to prevent movement of the connector position assurance from the locked position to the pre-lock position.

18. The electrical connector of claim 17, wherein the connector housing includes a shroud defining a window; and
wherein the assurance latch has a lift bar accessible through the window.

19. The electrical connector of claim 18, wherein the shield defines a shield axis and includes a first shield and a second shield, the first shield extending from the connection end to the contact end, the second shield separable from the first shield and extending from the connection end to the contact end, the first shield having a first side, a second side, and one or more tabs on the first side that engage the second shield, the second shield having a first side, a second side, and one or more tabs on the second side of the second shield that engage the first shield.

20. An electrical connector comprising:
a connector housing defining a connector cavity therethrough;
a terminal housing disposed within the connector cavity;
a shield disposed within the connector cavity and at least partially between the terminal housing and the connector housing, the shield extending from a connection end to a contact end, the shield defining a shield axis, the shield including a first shield and a second shield, the first shield having a first side, a second side, and extending from the connection end to the contact end, the second shield having a first side, a second side, and extending from the connection end to the contact end;
the first shield including a first outward tab of the first side of the first shield and a second outward tab on the second side of the first shield, the first outward tab of the first shield and the second outward tab of the first shield disposed on opposite sides of the shield axis;
the second shield including a first outward tab on the first side of the second shield and a second outward tab on the second side of the second shield, the first outward tab of the second shield and the second outward tab of the second shield disposed on opposite sides of the shield axis; and
a connector position assurance attached to the connector housing, the connector position assurance moveable relative to the connector housing between a pre-lock position and a locked position, the connector position assurance including an assurance catch;
wherein the connector housing includes a housing catch that engages the connector position assurance to deflect an assurance latch to a release position when the connector position assurance is moved from the pre-lock position to the locked position, and that engages the connector position assurance to prevent movement of the connector position assurance from the locked position to the pre-lock position;
wherein the connector housing includes a shroud defining a window that is located farther from the connector cavity than the assurance latch;
wherein the assurance latch has a lift bar accessible through the window; and
wherein the first outward tab of the first shield is disposed adjacent to the second outward tab of the second shield and the second outward tab of the first shield is disposed adjacent to the first outward tab of the second shield.
